(19) United States
(12) Patent Application Publication
(10) Pub. No.: US 2015/0174539 A1
(43) Pub. Date: Jun. 25, 2015

(54) APPARATUS FOR THE HOMOGENIZATION AND SEPARATION OF SAMPLES

(71) Applicants: ANDREAS HETTICH GAMBH & CO. KG, TUTTLINGEN (DE); KTB TUMORFORSCHUNGSGESELLSCHAFT MBH, FREIBURG (DE)

(72) Inventors: Klaus-Gunter Eberle, Tuttlingen (DE); Anke Lenz, Leibertingen (DE); Ulrich Massing, Merzhausen (DE); Vittorio Ziroli, March (DE)

(73) Assignees: KTB TUMORFORSCHUNGSGESELLSCHAFT MBH, FREIBURG (DE); ANDREAS HETTICH GMBH & CO. KG, TUTTLINGEN (DE)

(21) Appl. No.: 14/412,204

(22) PCT Filed: Jul. 2, 2013
(86) PCT No.: PCT/EP2013/063963

§ 371 Date: Dec. 30, 2014

(30) Foreign Application Priority Data
Jul. 2, 2012 (DE) 10 2012 105 819.9

(51) Int. Cl. B01F 9/00

(52) U.S. Cl. CPC B01F 9/0003; B01F 2009/0067

(57) ABSTRACT

The invention relates to an apparatus for the homogenization and separation of media (10), comprising a centrifuge (40, 70) having a centrifuge rotor (14, 44, 74) which can be rotated about a motor axis (A) of a centrifuge motor (12, 42, 72) and which includes a rotor body, connected to which is at least one rotation unit (16, 48, 80) in such a way that it is additionally adapted to be rotatable about an axis of rotation of a rotation unit, which axis is different from the motor axis (A), and that it can be driven via a rotation unit drive, with means being provided which can be used to set at least two different rotation speeds of the rotation unit (16, 48, 80), and furthermore the rotation unit (16, 48, 80) has toothing (8) on its periphery by which the rotation unit (16, 48, 80) can be driven. The invention is characterized in that the rotation unit drive comprises toothing which is associated with the centrifuge motor.

The invention relates to an apparatus for the dual centrifugation of samples.

Dual centrifugation (DC) is a process in which a sample is rotated about a main axis of rotation whilst simultaneously rotating about a secondary axis of rotation, which secondary axis of rotation may intersect the sample at any position thereof and may also be located outside the sample.

For this reason, a dual centrifugation apparatus comprises, in addition to a main axis of rotation, at least one additional axis of rotation, i.e. a secondary axis of rotation, about which a sample can be rotated. Typically, a means for receiving and holding a sample (sample holder) is rotated about the secondary axis of rotation.

Processes which are performed using a dual centrifugation apparatus, i.e. exploiting the interaction of two rotary motions, are referred to as dual centrifugation processes (DC processes). Such processes can be performed more efficiently than conventional processes as they involve the use of a dual centrifugation apparatus. Important examples include homogenization, mixing, tissue disruption.

US 2002/0172091 A1 relates to a dual asymmetric centrifuge for the production of food, in particular characterized by precisely one centrifuge container which can be rotated about a container axis and is rotationally symmetrical with respect to the latter. The container is mounted on the distal end of a rotating rotor arm. A shaft connects said container to a drive mechanism which is mounted on the end of the centrifuge rotor which is opposite said container. The speed of rotation of said container is set as a function of the centrifuge speed and at an invariable ratio. This has the disadvantage that samples which—owing to their specific sample properties—require a certain ratio of main rotation to reverse rotation that does not correspond to the ratio prevailing in this apparatus, cannot be processed. Furthermore, this apparatus cannot be used for pure centrifugation purposes.

Another simple type of dual asymmetric centrifugation which only includes one secondary axis of rotation is described in US 2003/0214878 A1.

This document discloses an apparatus for mixing fluid dispersions, in which a container is mounted to be rotatable about a first axis which is inclined with respect to a further axis of rotation that is connected to the container, i.e. a secondary axis of rotation. The first axis of rotation is driven by a motor. The second axis of rotation is connected to a wheel which is pressed against a solid contact surface. Rotation of the rotor arm will result in the wheel connected to the container and the container axis being guided along the contact surface which is stationary with respect to both the rotor arm and the container axis. This results in additional rotation of the container about the secondary axis of rotation which thus makes the speed of rotation of the container directly dependent on the centrifuge motor speed.

Disclosed in U.S. Pat. No. 5,352,037 is a dual symmetrical centrifuge including centrifuge containers mounted on a centrifuge rotor. Said centrifuge containers are rotationally symmetrical and mounted on the rotor arm so as to be rotatable about their axis of rotation (secondary axis of rotation). The containers are driven by a transmission coupled to said rotor. Consequently, the transmission ratio is fixed. As a result, the container speed of rotation is directly related to the centrifuge motor speed. This apparatus can neither be used for homogenization nor for pure centrifugation as this apparatus is not capable of realizing the long centrifugation time at a high speed of rotation.

U.S. Pat. No. 1,011,929 discloses an apparatus for mixing and separating media, which apparatus also includes a container that is rotatable about a main rotor. The containers in turn are mounted about an axis of rotation which is different from the main rotor, and are connected to the main rotor via a transmission. Separation can only be performed after sieve-like structures have been placed in the containers.

According to the present state of the art, it is possible to use a dual centrifuge for the purposes of mixing and homogenization of sample material.

However, the prior art apparatuses do not allow the separation of samples to be performed by means of centrifugation. A prior art dual centrifuge is not suited for use as a mere centrifuge as it will neither be able to survive the required duration of a centrifugation process nor will it withstand the high centrifugal and/or centripetal forces undamaged.

DE 101 43 439 A1 discloses a dual asymmetric centrifuge for mixing sample material in which a secondary axis of rotation is driven by a V belt, similar to what is described in US 2002/0172091 A1. Furthermore, it is described in this document that the ratio of main rotation to secondary rotation can be adjusted as required for the material to be centrifuged without making any major structural changes to the apparatus. This is achieved in particular by adapting the diameters of the driving and driven rollers. In this apparatus, the axle connecting the driven roller to an angular gear is provided with a rotary shaft seal to prevent lubricant leakage. This is disadvantageous in that, after long hours of operation of the apparatus, this seal will become leaky, and lubricant will leak out as a result of the centrifugal and/or accelerating forces prevailing in the area of the seal. This may damage the gear unit and also lead to the centrifuge interior becoming contaminated with lubricant. This problem occurs especially as the bearing heats up—which limits operation times of the apparatus to a maximum of 30 minutes.

Disclosed in JP 2009119587 A is a mixing apparatus comprising a centrifuge motor and a centrifuge rotor, with containers being rotatably mounted on the rotor and supported on the rotor by means of a rotation unit featuring toothing on its circumference. Reverse rotation is effected by a shaft of a rotation unit drive which is housed in a hollow shaft within a centrifuge motor.

It is the object of the invention to provide an apparatus for dual centrifugation which is capable not only of the homogenization, but also of the separation of sample material, and which can be better adjusted to the requirements of the sample material.

Contrary to a mere mixing process, homogenization requires the sample material to be exposed to clearly higher forces so as to ensure the splitting of particles required for the homogenization of especially liquid media such as emulsions or dispersions. Consequently, a high speed of rotation of the centrifuge rotor is required for the application of such high forces.

This object is accomplished by the preamble of claim 11 in combination with its characterizing features.

According to a first aspect of the invention, an apparatus for the homogenization and separation of media in a known manner comprises a centrifuge which includes a centrifuge rotor capable of rotating about a motor axle of a centrifuge motor, said rotor having a rotor body on which at least one rotation unit can be mounted in such a way that it can be rotated about an axis of rotation of a rotation unit which is different from the motor axis, which rotation unit is provided with a drive for generating the rotary motion of the rotation unit.

According to the invention, the rotation unit is accommodated in a recess provided in the rotor body and which is closed at the bottom. In addition, a bearing is provided for supporting the rotation unit, which bearing is disposed below the position of the centre of gravity of the centrifuge container during centrifugation.

For this reason, a potential receptacle portion of the rotation unit is substantially located outside the rotor body. As a consequence, the receptacle portion is subjected to the air flows created during rotation of the rotor. This allows for improved cooling of the samples accommodated in the receptacle portion.

The fact that the recess is closed at its bottom ensures that any lubricant leaking from a bearing will be contained within said recess for the entire centrifugation time and will thus be available in the area of the bearing. The bearing will thus be well lubricated during the entire operation period, thus preventing seizure.

The design according to the invention thus yields a dual centrifuge which will ensure a sufficiently long operation time and, at the same time, appropriately high centrifugal forces for centrifugation purposes as well as for efficient homogenization processes. Consequently, in addition to simple blending and mixing procedures, this apparatus will also be capable of performing separation and homogenization procedures.

Combining the high forces required for homogenization with a reverse rotation of the centrifuge containers and long run times is not feasible with the prior art apparatuses. However, this can be accomplished using the specific mounting of the present invention.

Preferably, lubricant can be filled into the recess and received in it in such a way that it will also remain within the recess during centrifugation.

The fact that lubricant can be filled into the recess separately ensures improved lubrication as opposed to cases in which lubricant exits a bearing. In particular, the lubricant is provided in the form of a homogeneous lubricant in order to prevent its separation during centrifugation. Preferably oil can be used as a lubricant.

In a particularly preferred embodiment, the rotation unit is connected to the centrifuge rotor via at least one roller bearing. Roller bearings constitute a particularly effective type of bearing.

If the rotation unit is supported by roller bearings, in particular ball bearings, relative to the centrifuge rotor, filling the recess with lubricant is considered advantageous here as well. The filling level may be chosen such that at least part of the existing roller bearings will be thinly covered with lubricant.

Preferably, the rotation unit will be supported with respect to the rotor body in such a way that the rotation unit is connected to the inner ring of the bearing and the rotor body is connected to the outer ring of the bearing. In addition, the rotor body can enclose the bearing at least partially at the bottom of the bearing.

Configuring the bearing in this way ensures that the lubricant contained in the bearing and which will also be exposed to centrifugal forces and thus be urged out of the bearing will be retained within the centrifuge rotor. In this way the lubricant will collect in the tray inside the rotor body. The centrifugal forces occurring will cause any lubricant that has leaked out to be collected on the radially exterior wall of the tray. A bearing configuration in which the outer ring of the bearing contacts the radially exterior wall of the recess will facilitate lubrication of such a bearing during centrifugation and thus require less lubricant to be used.

In yet another advantageous embodiment the bearing is provided in the form of an angular contact bearing. This allows optimal absorption of forces during centrifugation. Advantageous settings for an angular contact bearing will be obtained at an angular range of between 5° and 85°, preferably between 25° and 65°, with between 40° and 50° being the particularly preferred range. These angles may be chosen irrespective of the scope of application.

The angular contact bearing is designed for an angle of in particular 45°. This embodiment takes account of the installation location of the rotation unit, in particular in the case of an angle rotor.

In yet another advantageous embodiment, the rotation unit may be connected to the rotor body via a shaft extending into the latter. In particular, due to the fact that the bearing is encompassed and accommodated within the rotor body, the bearing can be supplied with additional lubricant. In this way it can be ensured that the bearing will constantly be covered with lubricant, at least on an external side thereof, thus prevent bearing seizure. As the lubricant will remain within the recess, this will also prevent contamination of the environment.

The rotation unit inserted in the bearing may be connected to a holding fixture.

Preferably, the rotation unit may be of a diameter which corresponds to approximately half of the diameter of the rotor. A range of between 30% and 45% of the rotor diameter is considered particularly suitable. This will yield a high degree of flexibility in the design of the holding fixtures. In particular, the axis of rotation of the rotation unit will be inclined with respect to the main axis of the rotor.

The rotation unit supported by the bearing may be provided as an integral unit with a holding fixture, in particular a cage. The holding fixture preferably has recesses, which results in improved dissipation of the heat generated during operation. When samples are processed according to the prior art, temperatures of up to 80° may arise in a sample container inserted in the holding fixture, thus making it impossible to process temperature-sensitive samples. The recesses provided in the walls of the holding fixture allow circulating air flows to be advantageously used during rotation in order to cool the sample containers and/or the samples contained in them. This has the advantage that temperature-sensitive samples can thus also be processed.

As an alternative, a holding fixture, in particular a cage, may be releasably mounted on the rotation unit. A sample container containing material to be centrifuged can be inserted into the holding fixture.

The holding fixture may also be designed as a centrifuge container which can be releasably mounted on the rotation unit. In this case, the material to be centrifuged will be introduced directly into the holding fixture.

Furthermore, reduction means may be provided which, on the one hand, can be placed in the holding fixture, and on the other hand provides a holding function for one or plural centrifuge containers. The use of reduction means for the relatively large diameter of the rotation unit makes it possible to use the apparatus according to the invention with a wide variety of vessels, a large number of sample containers, and sample containers of an elongated design, such as Falcon® tubes.

The design, in particular the size and geometry, of the reduction means has been adapted to the centrifuge containers provided and to the holding fixture.

The reduction means may also be connected directly to the rotation unit, without any holding fixture in between.

The reduction means in particular features recesses in its circumference. This leads to improved dissipation of the heat created due to the high rotation speeds from the sample container.

Preferably toothing is provided on the rotation unit which is adapted to mesh with a gear for the purpose of transmitting the rotary motion.

The fact that the rotary motion is transmitted by means of a gear or a gear drive allows a dual centrifugation process to be performed continuously over a long period of time.

The gear made to mesh with the rotation unit may be a drive gear or a transmitting gear.

A drive gear is characterized by the fact that there is a relative rotary motion between the drive gear and the centrifuge rotor. This is also the case with a stationary gear.

This for example allows the rotary motion of the centrifuge rotor to be transmitted to the rotation unit once the drive gear has meshed with the toothing on the rotation unit.

In yet another embodiment of the invention, a transmitting gear may be provided between the drive gear and the toothing on the rotation unit. This embodiment has the advantage that adapting the diameters of the drive and transmitting gears will allow a simple setting of different rotary speed ratios. Furthermore, a transmitting gear will yield increased flexibility as far as the arrangement of the sample containers on the centrifuge rotor is concerned.

It is considered particularly advantageous to design the centrifuge as a dual symmetrical centrifuge. This has the advantage that the processing volume will be increased owing to the presence of at least two rotation units, in particular rotatable centrifuge containers, as compared to one dual asymmetric centrifuge. Asymmetric centrifuges moreover have the disadvantage that they need to entrain a dummy weight so as to compensate for unbalances. Precise adjustment as is particularly required for higher rotary speeds is complex and moreover limiting since the dummy is pre-defined and the weight on the side of the samples must not exceed the weight of the dummy. If the weight of the sample is lower than that of the dummy, balancing weights need to be provided. Great care must be taken here since this might otherwise result in unbalance.

According to yet another aspect of the invention, an apparatus for the homogenization and separation of media is provided which includes means which can be used to set at least two different rotary speeds of the rotation unit.

In similar DC processes such as the production of small amounts of liposomes in different vessels, clearly different process parameters need to be applied, in particular a different ratio of main rotation to secondary rotation.

The prior art devices have the disadvantage that they do not allow the setting of optimal conditions for a defined DC process, as they are required for example for homogenization for the production of nanoparticles. In this case, the process parameters need to be adapted and adjusted with regard to their mutual ratios and with regard to the sample amount to the ratio of main rotation and reverse rotation.

It is the object of the invention to provide an apparatus which allows optimal adjustment of the conditions for different DC processes.

This object is accomplished by the characterizing features of claim 1 or 5 in combination with the features of its respective preamble.

In order to improve on a dual centrifuge device, the apparatus of the invention comprises in a known manner a centrifuge having a centrifuge rotor which can be rotated about a motor axis of a centrifuge motor. At least one rotation unit can be mounted on said centrifuge rotor in such a way that the former is mounted so as to be rotatable about a secondary axis of rotation which is different from the axis of the motor.

The invention is characterized in that means are provided which can be used to set at least two different rotary speeds of the rotation units. The rotation of the rotation units about the secondary axis of rotation is also referred to as reverse rotation.

It has surprisingly been found that parameters such as amount and material ratio can be compensated by adjusting the speed of rotation. This makes it possible to maintain these parameters and still yield ideal results in dual centrifugation processes.

Such more precise adjustment of the reverse rotation speed and/or the ratio of main rotation to reverse rotation now also allows use of an apparatus for dual centrifugation for performing sensitive processes which previously could not be handled by dual centrifugation apparatus.

For example in pharmaceutical development, where DC processes need to be performed and/or optimized with smaller amounts of samples first and with larger quantities later on, various DC apparatuses need to be available. Holding various DC apparatuses ready is not only costly but also takes up a lot of precious laboratory space.

In particular, means are formed such that a defined ratio of main rotation to reverse rotation can be set, said means being provided in the form of a mechanical coupling which can be used to vary the ratio of main rotation to reverse rotation in a fast and easy manner. The mechanical coupling is accomplished in particular via a gear connection which allows the setting of a precise and reproducible reverse rotation ratio. The rotation unit drive comprises toothing which is connected to the centrifuge motor.

Preferably these means are designed such that a central sprocket which is rigid with respect to the motor axis can be mounted on the motor casing. The centrifuge rotor has a pair of gears, the first gear of which engages the sprocket mounted on the motor casing. The second gear meshes with the toothing provided on the rotation unit. Owing to the size ratios of the central sprocket and the pair of gears, different transmission ratios of main rotation to reverse rotation may thus be implemented by simply exchanging the centrifuge rotor and the central sprocket.

In an embodiment that is considered particularly advantageous, the means for adjusting the reverse rotation speed are designed such that they allow the reverse rotation speed to be changed during centrifugation.

In particular, the reverse rotation speed and/or the ratio of main rotation to reverse rotation may be set continuously or incrementally, it may depend directly on the main rotary motion or may be adjusted via a variable transmission or may be adjustable independently of the latter.

There may also be two secondary axes of rotation, and the directions of rotation of these two axes of rotation can be chosen as desired. Depending on the specific application, the axes of rotation may either both rotate in the same direction or in opposite directions (relative to the main rotation).

In accordance with the present invention, only one means for rotating the rotation units about a secondary axis of rotation may be provided. However, there may also be plural means which are arranged symmetrically.

In this case, the rotations about the secondary axes of rotation may be synchronous or also uniform, the arrangement (position, angle to the main axis of rotation) of the secondary axes of rotation may be chosen as desired, with a rotationally symmetrical arrangement being preferred, however.

One way of adapting the speed of rotation of the rotation unit is by using a DC exchangeable turret with different ratios between main rotation and secondary rotation. An exchangeable turret preferably has a fixed transmission means which transmits the rotary motion of the centrifuge rotor to the rotation unit at a fixed ratio.

The connection unit between the centrifuge rotor and the centrifuge motor is designed such that rotors having different transmission means with different transmission ratios can be exchanged easily on the centrifuge motor. Besides affording a certain degree of flexibility in the adjustment of the rotation speed, the use of an exchangeable turret also has the advantage that the amount to be processed and/or the container size can be varied as a function of the exchangeable turret used in each case. This saves expensive laboratory space, as one basic device can be used for different requirements. Moreover, an appropriate basic device can also be used as a conventional centrifuge.

In particular, an apparatus of the present invention has a stationary sprocket which is non-rotatably connected to the centrifuge housing. As transmission means, at least one pair of gears may be provided. In the mounted state, a first gear thereof will mesh with the stationary sprocket, and a second gear thereof will engage the rotation unit.

In a first alternative embodiment, the centrifuge rotor may include a first gear which is matched to a standardized sprocket. The diameter ratio of the first gear to the second gear will determine a fixed ratio of main rotation to reverse rotation with respect to the centrifuge rotor.

According to another alternative embodiment, the toothing provided on the rotation unit may directly engage a gear provided on the centrifuge motor. The rotary speed ratios may be adapted by exchanging the gear and the rotation units.

This thus allows the ratio of main rotation to reverse rotation to be changed by simply exchanging the centrifuge rotor.

According to a second alternative embodiment, the sprocket which is non-rotatably mounted may be exchangeable. The fact that the non-rotatably mounted sprocket can be exchanged allows the diameter of this sprocket to be adjusted to the diameter of a first exchangeable gear of a pair of transmitting gears. Adjusting the diameter of the sprocket to the first gear of the pair of transmitting gears is a simple way of adjusting the ratio of main rotation to reverse rotation without having to provide plural DC rotors.

An improvement is achieved by designing the rotation unit such that its speed of rotation can be adjusted at the same main speed of rotation without having to make a substantial structural change to the actual apparatus. The container drive will thus be capable of realizing at least two different speeds at the same main speed of rotation. The fact that the speed of rotation about a secondary axis of rotation can be adjusted allows for a significant increase of the scope of application of a DC apparatus.

A special advantage is obtained by decoupling the rotary speed of the centrifuge motor from that of the container drive so that the container may also reach a negative speed with respect to the rotor. This corresponds to switching between forward and reverse rotation of the container relative to the main rotation of the rotor. Amongst other things, this will allow two different homogenization or mixing modes to be accomplished in one DC process, if for example the inner surface of the container is designed such that the material to be homogenized or mixed will be exposed to a different kind of friction each—depending on the direction of rotation. This may be accomplished by providing a directionally structured surface.

In yet another advantageous embodiment, the rotation unit can be connected to a drive gear, in particular the central gear, via a freewheel. In this way, the rotary motion will only be transmitted in one direction of rotation. Accordingly, the freewheel can be used to mechanically decouple the rotary motion of the container, by reversing the main direction of rotation. This has the advantage that the rotary motion of the container can be interrupted so as to allow a separation or concentration process to be initiated following a mixing or homogenization DC process. In yet another embodiment, a central gear may be connected to the main rotor via coupling means in such a way that the central gear can be non-rotatably mounted, if required, by means of catch means. If required, this will thus allow the gear to be decoupled before the centrifuge axis. Consequently, the rotation will no longer be transmitted to the rotation units, thus ensuring a pure centrifugation of the samples.

A particular advantageous implementation of the adaptability of the rotary speed of the containers can be achieved by connecting the rotation unit drive to the centrifuge motor via a conventional transmission. The switch-over can be performed mechanically during non-operation of the apparatus, or the conventional transmission can be formed as an electrically operated transmission. An electrically operated transmission can also be used as a simple means of changing the rotary speed even during operation.

In particular, where there are plural rotation units, these are coupled in pairs with respect to their speeds. For example, for a total of four rotation units, two opposing rotation units may thus be operated at a certain transmission ratio, whilst the other two opposing rotation units may be operated at a different transmission ratio.

In a particularly advantageous embodiment, the transmission may be incorporated in the DC rotor of the centrifuge. Switching the transmission may for example be accomplished through an electrical circuit, with the energy for switching the transmission being derived from the rotation of the centrifuge rotor.

In an alternative embodiment, the transmission may also be incorporated in the rotation unit to be inserted in the centrifuge rotor, however. This has the advantage that the rotary speeds or speed ranges can be determined depending on the rotation unit inserted.

It is also possible to switch a transmission that has been inserted in a rotation unit.

In yet another advantageous embodiment, the rotation unit drive is connected to a rotation unit motor which is independent of the centrifuge motor. This yields the advantage that the speed of rotation can be varied over a clearly vaster range than is possible when a mechanical transmission is used. Moreover, the rotation speed can be varied continuously which thus allows an optimum adaptation to the DC process. In addition, this also allows a reversal of the direction of rotation, or a complete switch-off, of the secondary rotation.

This motorized drive of the rotation unit may preferably be incorporated in the centrifuge rotor. The electric motor for driving the secondary rotation may preferably be controlled through contactless transmission of energy and signals. For the contactless transmission of energy, a transmitter is provided which may take the form of a generator, for example, and which will provide energy on the side of the rotor through the relative motion between the rotor and the centrifuge. Alternatively, sliding contacts may also be used for the transmission of energy.

Owing to this energy and signal transmission, a temperature sensor can be incorporated in the vicinity of the sample container. The presence of a temperature sensor in combination with the signal transmission to the main rotor allows a temperature-based control of main rotation and secondary rotation. Adjusting the main rotation and the secondary rotation allows the sample temperature to be adjusted which thus ensures that also heat-sensitive samples can be processed reliably. Furthermore, it is also possible for example to display the temperature on a display means provided on the apparatus or to output the temperature data acquired over the operating time at an interface provided for this purpose. This kind of documentation may thus also provide evidence that the sample has not exceeded a certain maximum temperature over the entire centrifugation time.

Preferably a combination of two to four rotation units driven by two rotation unit motors may be used. The two rotation unit motors are symmetrically mounted in the rotor. According to the prior art, contactless energy transmission by way of a transmitting unit will only allow a limited amount of power to be transmitted. However, the provision of two motors makes it possible to use two transmitting units which thus increases the driving power per rotation unit.

However, in yet another embodiment, only one container motor may be used for driving the rotation units of preferably two to four rotation units. The rotation unit motor will then in particular be coaxially mounted on the rotor with respect to the main axis of rotation for which reason it will only be exposed to a limited extent to the centrifugal forces.

The electromotive drive may be connected to the main drive by means of a mechanical coupling via a gear transmission or a V belt, as in the case of the mechanical drive. In addition, toothing may in particular also be provided on the rotation unit.

In a particularly advantageous embodiment, the electric drive motor for the rotation unit may be in the form of a stepper motor. Using a stepper motor allows the containers to be positioned more precisely. This is beneficial for the performance of a DC process in which a mixing process is to be combined with a separation, as is the case for example in a liquid-liquid extraction or a liquid-solid extraction.

In yet another advantageous embodiment, the holding fixture may include entrainment means for locking or fixing the reduction means or sample containers with respect to the holding fixture. This on the one hand ensures reliable positioning during the centrifugation and/or mixing process; on the other hand it also ensures that the reduction means or containers are fixed in the direction of rotation. Preferably, the sample may also be held in the centrifuge container by means of a separate sample vessel. This may be accomplished by way of an adapter which is specifically adapted to the centrifuge container.

A particularly advantageous application of the above mentioned invention is in a process for producing nanoparticles.

Further advantages, features and potential applications of the present invention may be gathered from the description which follows, in conjunction with the embodiments illustrated in the drawings.

Throughout the description, the claims and the drawings, those terms and associated reference signs will be used as are notable from the enclosed list of reference signs. In the drawings is shown

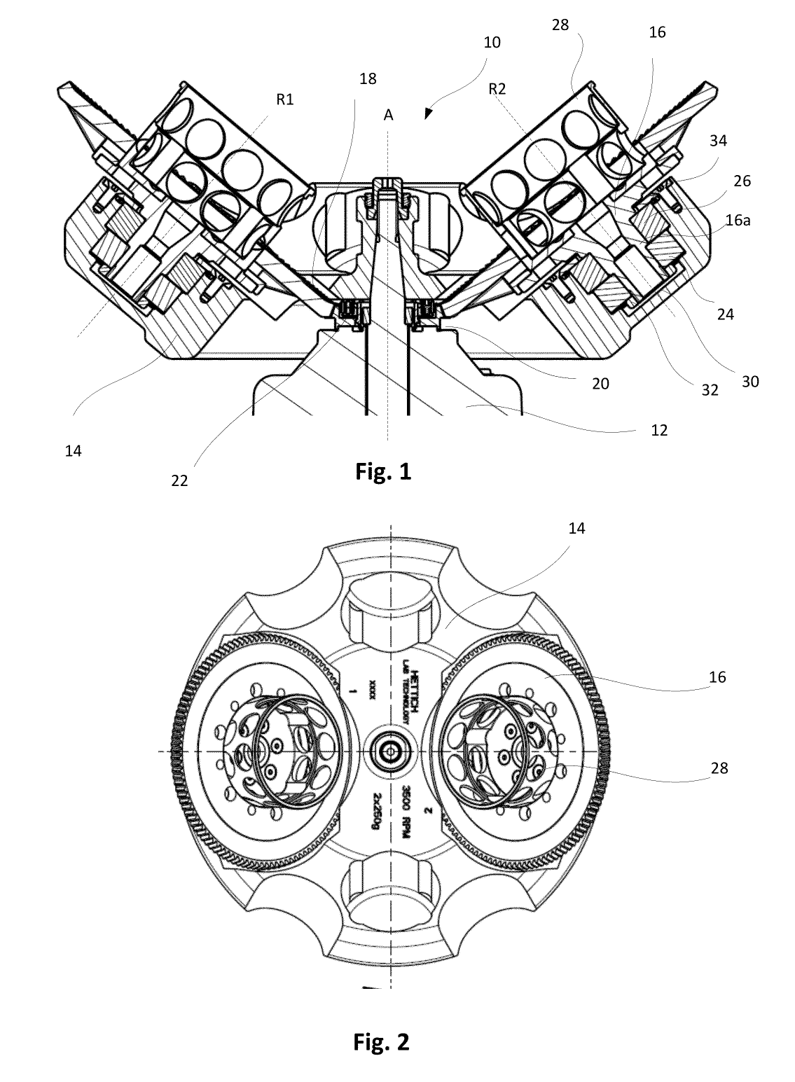

FIG. 1 a sectional view of an apparatus according to the invention, in which the rotation units provided with toothing are driven by a central gear;

FIG. 2 a top view of the apparatus of FIG. 1;

FIG. 3 a sectional view of an apparatus according to the invention, in which the rotation units provided with toothing are driven by a central gear, via a pair of transmitting gears;

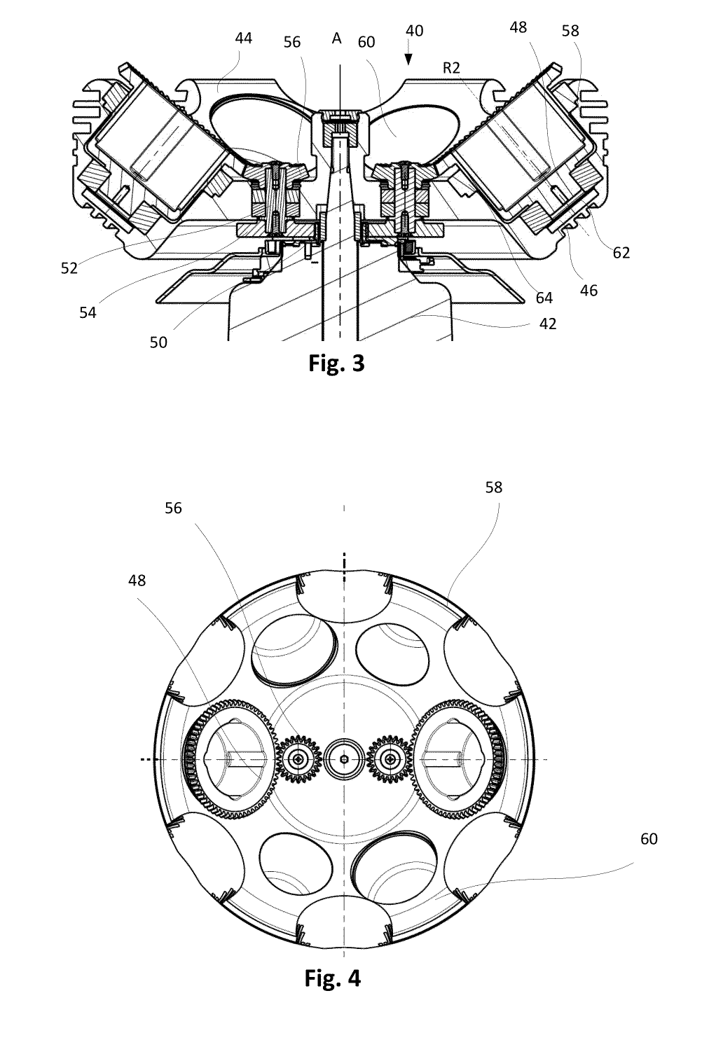

FIG. 4 a top view of the apparatus of FIG. 3;

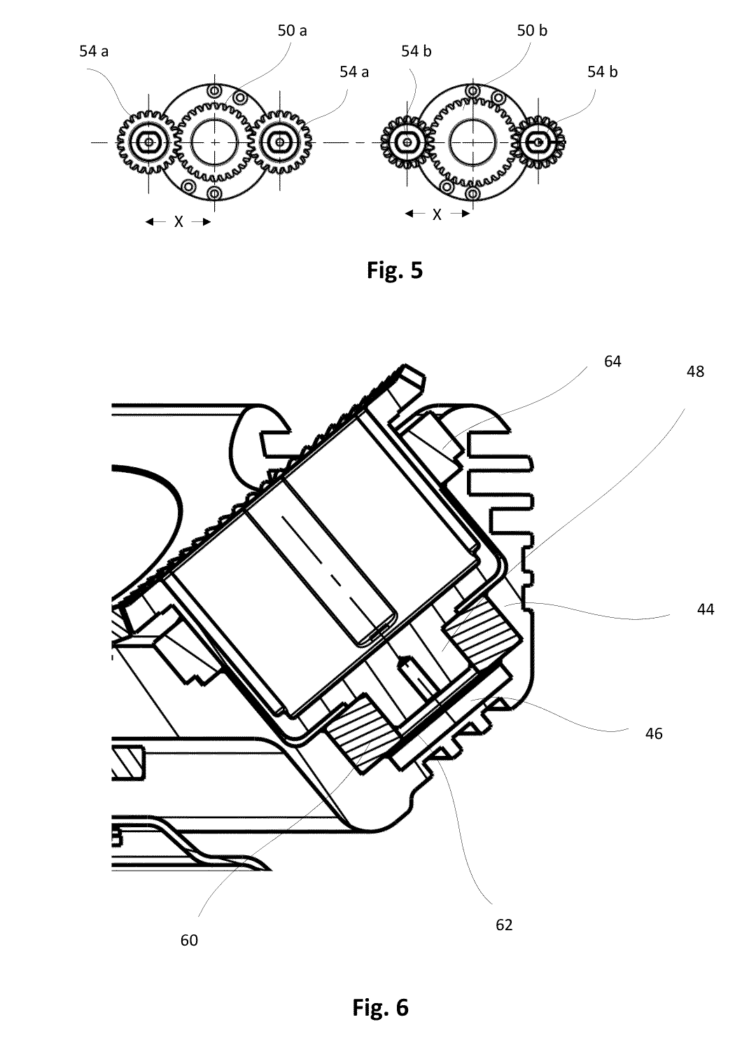

FIG. 5 a top view of configurations of the central gear and the transmitting gear;

FIG. 6 a sectional view of the rotor body and the rotation unit which latter is accommodated in a recess in the rotor body;

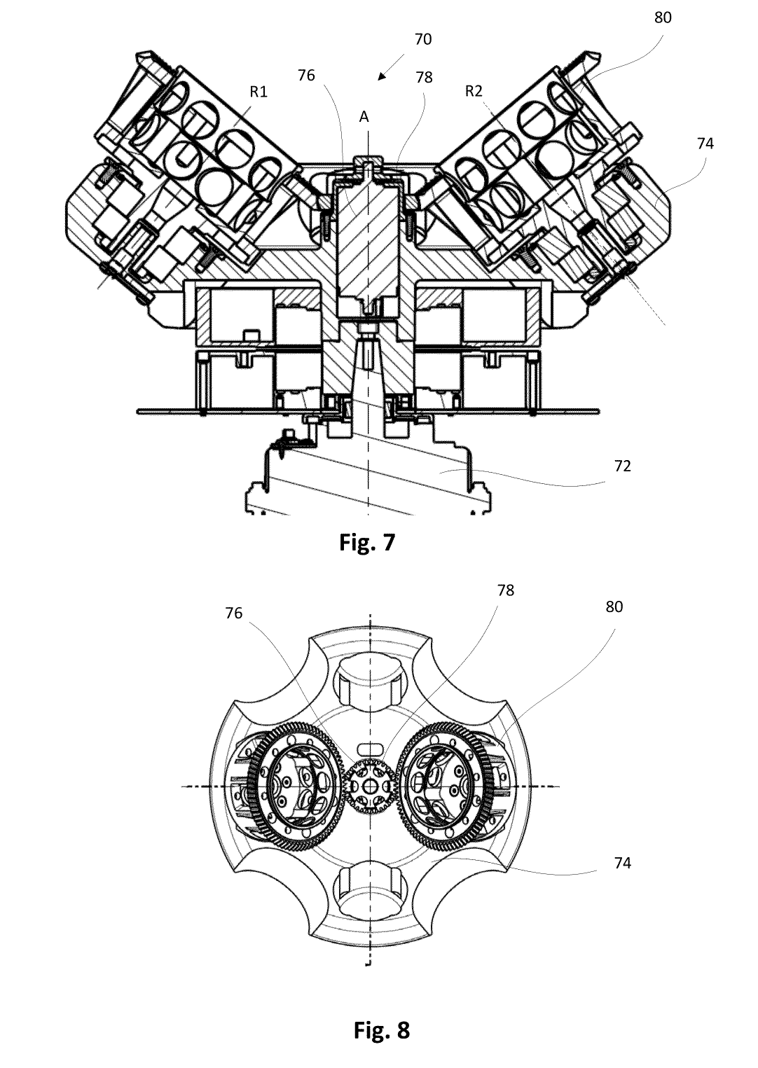

FIG. 7 a sectional view of an apparatus, with a central electric motor being provided for driving the rotation units;

FIG. 8 a top view of the apparatus of FIG. 7;

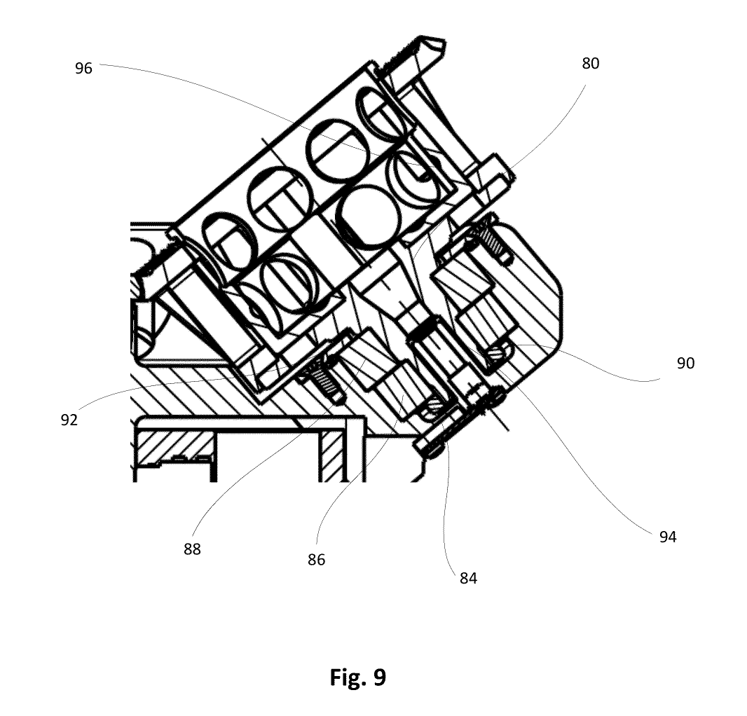

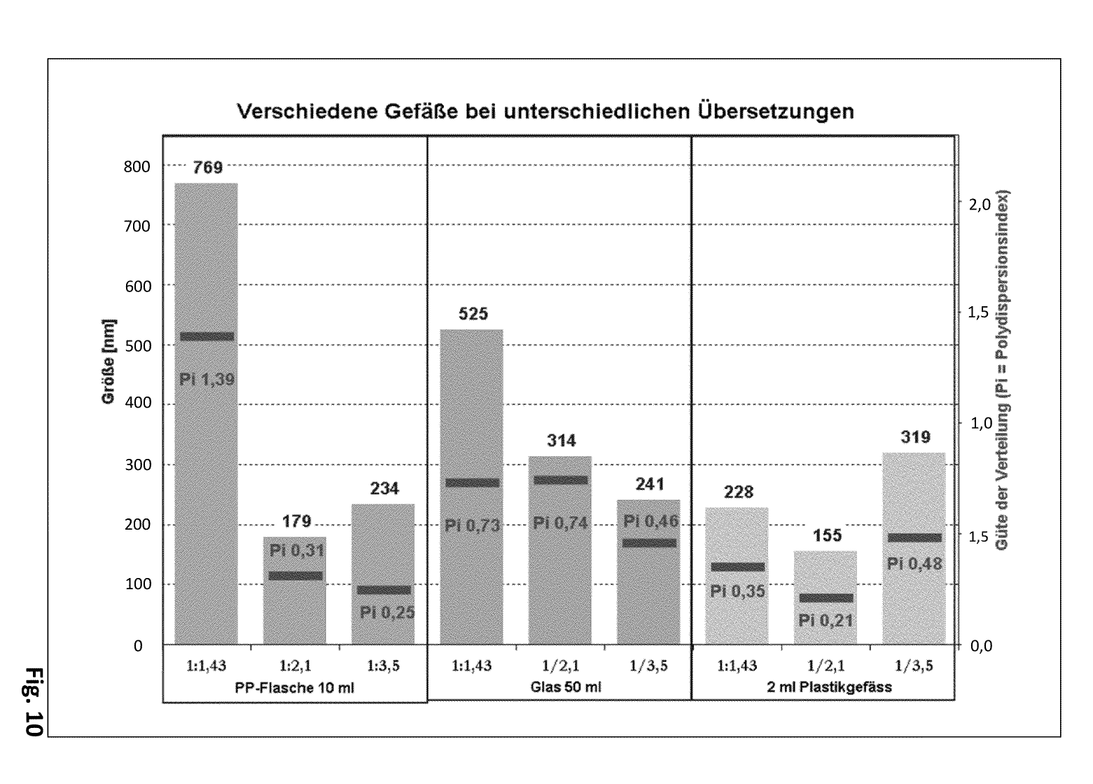

FIG. 9 a sectional view of the rotor body and of the rotation unit which latter is accommodated in a recess in the rotor body, and

FIG. 10 a chart of measurement results regarding the quality of dispersion in the production of liposomes under different conditions.

The view of FIG. 1 shows a dual centrifuge 10 for the homogenization and separation of media, comprising a centrifuge motor 12 and a centrifuge rotor 14. The centrifuge rotor 14 rotates about an axis A which corresponds to the drive axle of the centrifuge motor 12. The centrifuge rotor 14 is connected to rotation units 16 which are mounted so as to be rotatable about their axes of rotation R1, R2. The rotation units 16 have gear teeth 18 on their peripheral sections which mesh with a gear 22 which is non-rotatably mounted on the centrifuge motor housing 20. Rotation of the centrifuge rotor 14 about the motor axis A with respect to the motor 12 will cause the rotation units 16 to rotate about their rotation unit axis R. Each rotation unit 16 is mounted in the centrifuge rotor 14 in a recess 30 specifically provided in the centrifuge rotor 14 for this purpose, into which two bearings 24, 26, which take the form of angular contact ball bearings, per rotation unit 16 have been inserted. Via their outer rings, these angular contact ball bearings are supported on the recess in the centrifuge rotor 14. The inner ring of each bearing is connected to the shaft 16a of the rotation unit 16. The recess 30 provided in the body of the centrifuge rotor 14 is designed so as to be closed at its base, in particular to be cup-shaped. This design of the holding fixture of the rotation unit 16 makes it possible to retain any lubricant leaking from the bearing 24, 26 within the centrifuge unit and/or the centrifuge rotor 14 and thus to ensure lubrication of the ball bearings 24, 26 even if the lubricant has exited the actual bearing 24, 26.

The centrifugal force occurring during rotation of the centrifuge rotor 14 will urge the lubricant toward the radially outer “cup” edge of the cup-shaped recess 30 where it will then collect. In this way, the ball bearings 24, 26 can still be continuously lubricated in operation, using lubricant that has already leaked out. This allows a high rotation speed both of the centrifuge rotor 14 and the rotation unit 16 to be achieved at long run times.

Furthermore, as in shown in FIG. 1, the rotation unit 16 has its shaft 16a extending through the ball bearings 24, 26, with a clamping ring 32 provided on the end of the shaft 16a which clamps the ball bearings 24, 26 in position with respect to the rotation unit 16. Furthermore, mounted on the top of the body of the centrifuge rotor 14 and/or on the top of the cup-shaped recess 30 is a plate 34 which will retain the ball bearing array within the rotor body. In addition, this constitutes some kind of cover in order to prevent the leaking out of lubricants from the centrifuge cup during centrifugation.

FIG. 2 is a top view of the centrifuge rotor 14 of FIG. 1. As can clearly be seen from this view, the rotor 14 has two rotation units 16 extending in a first axis, each having a cage 28 screwed onto it. At least one sample vessel containing material to be centrifuged can be inserted into said cage 28. In the axis extending orthogonally to the first axis, there are two spaces for pure centrifugation purposes. Centrifugation containers placed in these spaces cannot be rotated about their own axis.

FIG. 3 is a sectional view of a centrifuge 40 for the homogenization and separation of media in which the reverse rotation speed of the rotation units 48 can be set in a simple manner. The centrifugation apparatus 40 comprises a centrifuge motor 42 which rotates about the motor axis A. A centrifuge rotor 44 can be mounted on the centrifuge motor 42 by means of a bolted connection. Cup-shaped recesses 46 are provided in the body of the centrifuge rotor 44. These cup-shaped recesses 46 will accommodate rotation units 48 for dual centrifugation. The structure of these rotation units 48 will be described in more detail below with respect to FIG. 6. A central gear 50, which is non-rotatably mounted with respect to the centrifuge rotor 44, is provided for transmitting the rotary motion about the rotation axis R1, R2 of the rotation units 48. This gear 50 can be easily connected to the non-rotatably mounted motor casing, for example by means of a bolted connection, after the centrifuge rotor 44 has been removed.

Furthermore, for transmitting the relative rotary motion between the rotor 44 and the centrifuge motor 42, pairs 52 of gears are provided, with one pair 52 of gears comprising a first gear 54 which meshes with the central gear 50, and a second gear 56 which engages the toothing on the rotation unit 48. The ratio of main rotation to reverse rotation is thus defined by the transmission ratio of the gear array 50, 54, 56. In view of the fact that the gears 54, 56 of the pair 52 of gears can be exchanged easily, the speed ratio can also be changed easily by simply adapting the diameters of the gears 54 and the central gear 50 which is engagement with it. One example for gear configurations 50, 54 for different speed transmissions is shown in FIG. 5. Adapting the reverse rotation speed of the rotation units 48 can thus be achieved in an easy way by exchanging a mere three components. Furthermore, if one replaces the rotor, the centrifuges can also be used as a “normal” centrifuge.

FIG. 4 is a top view of a centrifuge rotor according to FIG. 3, which quite clearly shows the first gear 56 of the pair 52 of gears as it meshes with the toothing provided on the rotation unit 48. Furthermore, cooling means 58 are provided on the rotor, in the form of cooling fins or recesses so as to increase the surface for improved heat dissipation. As in the embodiment of FIG. 1, some additional centrifugation spaces 60 are also provided here for “normal” centrifugation.

FIG. 5 is a view of two sets of a central gear 50a, 50b and of the gear 54a, 54b of the gear pair driving the rotation unit, which gear 54a, 54b meshes with said central gear 50a, 50b. It can be understood quite well from the view of FIG. 5 how changing the gear diameter of the central gear 50a, 50b and of the first gear 54a, 54b of the transmitting gears allows the speed ratio to be adjusted without having to vary the centre distance X. Exchanging these two components constitutes an easy way of changing the ratio of main rotation to reverse rotation.

FIG. 6 is an enlarged view illustrating how the rotation unit 48 is accommodated within the rotor body 44. The rotor body 44 has a cup-shaped recess 46 for accommodating the rotation unit 48. This recess houses a ball bearing, in particular an angular contact ball bearing 60. A retaining plate 62 is used to brace this bearing with respect to the rotation unit 48. Moreover, disposed at the top of the recess 46 is a sliding contact bearing 64 for mounting the rotation unit 48. The cup-shaped recess 46 in the rotor body 44 is designed such that any lubricant exiting the ball bearing during centrifugation will collect in the radially outer portion of the centrifuge rotor 44 at the level of the ball bearing and thus provide lubrication for these components. Consequently, high rotation speeds and thus accordingly high centrifugal forces can be provided. This continuous lubrication cycle also ensures long run times of the centrifuge.

FIG. 7 is a view of a dual centrifuge 70 having a variable reverse rotation speed. Typically, this centrifuge has a centrifuge motor 72 onto which a centrifuge rotor 74 has been placed. The centrifuge rotor 74 of this embodiment comprises an additional rotation unit motor 76 which is provided with a drive gear 78 which in turn meshes with the toothing of the rotation unit 80 and thus ensures corresponding rotation of the rotation unit 80 about the rotation unit axis R1, R2. The reverse rotation speed of the rotation units 80 depends on the speed of rotation of the rotation unit motor 76. Energy transmission for the rotation unit motor 76 is in particular wireless. The fact that the use of the electric motor as an independent rotation unit motor 76 allows the rotation speed to be adjusted and varied not only irrespective of the speed of rotation of the centrifuge rotor 74 but also during actual operation, makes it possible to implement a wide variety of applications. What is considered particularly advantageous is that adapting the speed of rotation, in particular the speed of reverse rotation, during operation also allows sample temperature control. This will be explained in more detail below with reference to FIG. 9.

FIG. 8 is a top view of the centrifuge rotor 74 which clearly shows how the toothing provided on the rotation units 80 meshes with the teeth of the drive gear 78 which is connected to the rotation unit drive motor 76.

FIG. 9 is an enlarged view of the embodiment illustrated in FIGS. 7 and 8. This design essentially corresponds to a rotor 74 in which an essentially cup-shaped recess 84 has been provided, the bottom of which forms a collection tray for the lubricant. Mounted within said cup-shaped recess 84, the one on top of the other, are two angular contact bearings 86, 88. These bearings are connected to the rotation unit 80 via a clamping ring 90 with largely no play between these components. The outer rings of the ball bearings 86, 88 are held within the cup-shaped recess 84 by a retaining plate 92 which is screwed to the centrifuge rotor. The rotation unit is thus firmly connected to the centrifuge rotor 74 in an axial direction. In this embodiment, the bottom of the cup-shaped recess 84 has a cylindrical raised portion which projects into a recess of the shaft of the rotation unit. This cylindrical raised portion ensures that the lubricant collection tray of the cup-shaped recess 84 has an essentially annular base. Mounted within said cylindrical raised portion 94 is a temperature sensor which is adapted to measure the temperature of the material to be centrifuged. Depending on the temperature thus measured, the rate and speed of rotation of the rotation units 80 may be modified such that a certain desired temperature can be set. The rotation unit is connected to a cage-like holding fixture 96 which has recesses in the form of holes so as to ensure improved heat dissipation from the heated sample. This holding fixture 96 will receive sample vessels or adapters and/or reduction means into which sample vessels have in turn been inserted.

FIG. 10 illustrates the specific application of producing liposomes at different speed ratios between main rotation and reverse rotation.

The subject of this examination was the production of liposomes through homogenization (30 min each) of a molecularly dispersed mixture of hydrated egg yolk phosphatidylcholine and cholesterol (55:45 mol/mol) with 60 wt.-% of water and the addition of 100 wt.-% of glass beads (1 mm). The DC homogenization process was examined for 10 ml PP vials (43.3 mm long and 23 mm wide), glass injection vials (50 ml, 42 mm in diameter) and 2 ml plastic vials (twist top vials).

Using the DC apparatus of the present invention with an exchangeable rotor of FIG. 3 in a standard Hettich Rotanta 460R type centrifuge, it was possible to set and examine different ratios of main rotation and secondary rotation (1:1.43, 1:2.1, 1:3.5). The results are shown in the chart. The DC homogenization process was conducted at a main rotation rate of 3,500 rpm.

The results indicate that—despite the similarity of the experiments (same DC homogenization process, same lipids, same homogenization aids etc.)—the use of different sample vessels already yielded clearly different ratios of main rotation and secondary rotation for the production of as small as possible liposomes with an as narrow as possible size distribution (low PI value). The desired, as small as possible liposomes having a low PI value are obtained in the PP vials, in particular at medium transmission ratios. This also applies to the use of the 2 ml plastic vials (twist top vials). By contrast, when using the 50 ml glass injection vials, smaller liposomes are preferably formed at higher transmission ratios.

This shows that there is no general optimal ratio between main rotation and secondary rotation for a certain DC process but that the optimum ratio will always have to be adapted to the specific conditions (in this case the type of vial). This clearly illustrates how important it is to be able to adjust the ratio of main rotation and secondary rotation, in particular for the production of liposomes.

### LIST OF REFERENCE SIGNS

10 dual centrifuge
12 centrifuge motor
14 centrifuge rotor
16 rotation unit
16a shaft
18 toothing
20 centrifuge motor housing
22 gear
24 bearing
26 bearing
28 cage
30 recess
32 clamping ring
34 plate
40 centrifuge
42 centrifuge motor
44 centrifuge rotor
46 recess
48 rotation unit
50 gear
50a gear
50b gear
52 pair of gears
54 gear
54a gear
54b gear
56 gear
58 cooling means
60 centrifugation space
62 retaining plate
64 sliding contact bearing
70 centrifuge
72 centrifuge motor
74 centrifuge rotor
76 rotation unit motor
78 drive gear
80 rotation unit
84 recess
86 angular contact bearing
88 angular contact bearing
90 clamping ring
92 retaining plate
94 raised portion
96 holding fixture
A axis
R1 axis of rotation
R2 axis of rotation

1. An apparatus for the homogenization and separation of media (10) comprising a centrifuge (40, 70) having a centrifuge rotor (14, 44, 74) which can be rotated about a motor axis (A) of a centrifuge motor (12, 42, 72) and which includes a rotor body, connected to which is at least one rotation unit (16, 48, 80) in such a way that it is additionally adapted to be rotatable about an axis of rotation of a rotation unit which is different from the motor axis (A), and that it can be driven via a rotation unit drive, with means being provided which can be used to set at least two different rotation speeds of the rotation unit (16, 48, 80), and furthermore the rotation unit (16, 48, 80) has toothing (8) on its periphery by which the rotation unit (16, 48, 80) can be driven, said rotation unit drive comprises toothing which is associated with the centrifuge motor.

2. The apparatus of claim 1, characterized in that the drive of the rotation unit is designed such that at least one transmitting gear (54a, 54b) is provided which meshes with toothing (50a, 50b) which is firmly mounted with respect to the rotating motor axle (A), and with the toothing (18) provided on the rotation unit (16, 48, 80).

3. The apparatus of claim 2, characterized in that the transmitting gear is provided in the form of a pair (52) of gears, of which a first transmitting gear (54) meshes with toothing (50) non-rotatably mounted with respect to the motor axis (A), and a second transmitting gear (56) meshes with the toothing (18) on the rotation unit.

4. The apparatus of claim 1, characterized in that the non-rotatably mounted toothing (50) can be placed over the centrifuge axle (A) and attached to the centrifuge motor housing (20).

5. An apparatus for the homogenization and separation of media (10) comprising a centrifuge (40, 70) having a centrifuge rotor (14, 44, 74) which can be rotated about a motor axis (A) of a centrifuge motor (12, 42, 72) and which includes a rotor body, connected to which is at least one rotation unit (16, 48, 80) in such a way that it is additionally adapted to be rotatable about an axis of rotation of a rotation unit which is different from the motor axis (A), and that it can be driven via a rotation unit drive, with means being provided which can be used to set at least two different rotation speeds of the rotation unit (16, 48, 80), and furthermore the rotation unit (16, 48, 80) has toothing (8) on its periphery by which the rotation unit (16, 48, 80) can be driven, said at least one rotation unit motor (76) which is independent of the centrifuge motor (12, 42, 72) is provided as the rotation unit drive and is mounted on the centrifuge rotor.

6. The apparatus of claim 5, characterized in that the rotation unit motor (76) is coaxially mounted with respect to the motor axis (A) on the centrifuge rotor (14, 44, 74).

7. The apparatus of claim 6, characterized in that for each rotation unit (16, 48, 80) one rotation unit motor each is provided.

8. The apparatus according to claim 5, characterized in that the transmission of energy and/or signals to the rotation unit motor (76) is wireless.

9. The apparatus according to claim 5, characterized in that the transmission of energy and/or signals to the rotation unit motor (76) is accomplished using sliding contacts.

10. The apparatus according to claim 5, characterized in that the rotation unit motor (76) is in the form of a stepper motor.

11. An apparatus for the homogenization and separation of media (10), comprising a centrifuge (40, 70) having a centrifuge rotor (14, 44, 74) adapted to be rotatable about a motor axis (A) of a centrifuge motor (12, 42, 72) and including a rotor body to which at least one rotation unit (16, 48, 80) can be attached in such a way that it can be rotated about a rotation axis of a rotation unit, secondary axis of rotation, which is different from the motor axis (A), with a drive of a rotation unit being provided for generating the rotary motion of the rotation unit (16, 48, 80), said rotation unit (16, 48, 80) being accommodated in a recess (30, 46, 84) having a closed base and provided within the rotor body, and, a bearing (24, 26) is provided for supporting the rotation unit, which bearing is disposed below the position of the centre of gravity of the centrifuge container during centrifugation.

12. The apparatus according to claim 1, characterized in that the rotation unit (16, 48, 80) is provided in the form of a turntable.

13. The apparatus according to claim 1, characterized in that the rotation unit (16, 48, 80) comprises a holding fixture (96) into which material to be centrifuged or a centrifuge container containing material to be centrifuged can be placed.

14. The apparatus of claim 12, characterized in that a reduction means is provided which can be placed in the holding fixture (96), and a centrifuge container can in turn be placed into said reduction means.

15. The apparatus according to claim 1, characterized in that the holding fixture (96) is provided in the form of a cage and has recesses (30, 46, 84), in particular in a circumferential direction thereof.

16. A method of operating an apparatus according to claim 1, characterized in that sample parameters are measured and the speed of rotation is set as a function of the sample parameters.

17. The method of claim 16, characterized in that the sample parameters measured are viscosity and/or temperature.
